(19) United States
(12) Patent Application Publication
(10) Pub. No.: US 2009/0277026 A1
(43) Pub. Date: Nov. 12, 2009

(54) Offset level

(76) Inventor: Benjamin Scott Teach, Covington, GA (US)

Correspondence Address: MICHAEL J. BOOTCHECK, LLC, P.O. BOX 3505, MCDONOUGH, GA, 30253, US

(21) Appl. No.: 12/151,387

(22) Filed: May 6, 2008

(51) Int. Cl. G01C 9/24

(52) U.S. Cl. 33/382

(57) ABSTRACT

Devices for commercial, industrial, professional and household use are described in offset levels. In one embodiment, the offset level may comprise at least two parallel but offset portions such that an individual may use the offset level to lay a level line even if here is an object in the way which would prevent use of an conventional straight level. In one embodiment, the offset level comprises at least three portions, two of which are co-axial and a third which is not co-axial with the other two and which is therefore offset.

### FIELD OF THE INVENTION

The present invention relates to geometric devices which can be used by an individual to determine levelness and orthogonality. The devices relates more specifically to offset levels which allow a user to lay a level line even if there is an obstruction in the line. The devices can be used by craftspersons and laypersons alike.

### BACKGROUND OF THE INVENTION

Craftspersons including tile installers, carpenters, plumbers, electricians, painters, artists, laborers, masons, contractors, construction personnel and others often have need to various tools in performance of various tasks such as levels, squares, straight edges, and rulers. Often times a craftsperson will use a plurality of tools in order to perform a given task. For example, in order for a tile installer to install tile in a bathroom stall, the installer must lay out a level horizontal line which he can then use to install the tile. Utilizing prior art devices for laying out such a line, a craftsperson would typically utilize a conventional straight level which the craftsperson could simply place against the wall, adjust the angle of the level such that the levelness indicator therein indicated that the level was horizontal (or vertical or at a given angle as the application required), and then to make a marking on the wall along an edge of the level with a writing or other marking utensil.

### SUMMARY OF THE INVENTION

The present invention is directed to novel offset leveling devices which allow an individual or user to utilize the devices to lay out lines around an object. The devices may be constructed to various dimensions and configurations to be used in a multitude of locations.

According to one exemplary embodiment of the present invention, the device comprises a frame having a first portion having a first surface, a second surface, a front surface, a back surface a first end surface and a distal end surface, a second portion having a first surface, a second surface, a front surface, a back surface a first end surface and a distal end surface, and a third portion having a first surface, a second surface, a front surface, a back surface a first end surface and a distal end surface, wherein said top surface of said first portion and said top surface of said second portion are co-planar and said top surface of said third portion is not co-planar with either of said top surfaces of said first or second portions.

In another exemplary embodiment, the device comprises a first portion having a first surface, a second surface, a front surface, a back surface a first end surface and a distal end surface, a second portion having a first surface, a second surface, a front surface, a back surface a first end surface and a distal end surface, and a third portion having a first surface, a second surface, a front surface, a back surface a first end surface and a distal end surface, a longitudinal axis located midway between said first and second surfaces of said first portion, a longitudinal axis located midway between said first and second surfaces of said second portion a longitudinal axis located midway between said first and second surfaces of said third portion wherein said longitudinal axis of said first portion is not co-axial with said longitudinal axis of said third portion.

Another embodiment comprises an offset level for use by one person on a surface with one or more surface obstructions which prevent a user from laying a line on both sides of said obstruction, the offset level comprising: (a) a frame having a first portion having a first surface, a second surface, a front surface, a back surface a first end surface and a distal end surface, a second portion having a first surface, a second surface, a front surface, a back surface a first end surface and a distal end surface, and a third portion having a first surface, a second surface, a front surface, a back surface a first end surface and a distal end surface, wherein said top surface of said first portion and said top surface of said second portion are co-planar and said top surface of said third portion is not co-planar with either of said top surfaces of said first or second portions; and (b) at least one levelness indicator which is capable of indicating whether said level is in at least one of a horizontal condition, a vertical condition or a 45 degree angle between said vertical condition and said horizontal condition.

### BRIEF DESCRIPTION OF THE FIGURES

FIG. 1 depicts a perspective view of an exemplary embodiment of the present invention;

FIG. 2 illustrates a front exploded view of another exemplary embodiment of the present invention;

FIG. 3 illustrates a front exploded view of another exemplary embodiment of the present invention;

FIG. 4 illustrates a front view of another exemplary embodiment of the present invention;

FIG. 5 illustrates a front view of another exemplary embodiment of the present invention;

FIG. 6 illustrates a perspective view of an exemplary level in use in a shower/tub setting;

FIG. 7 illustrates an exploded view of the embodiment of FIG. 3 in which several members have been rotated so that the device is in a second orientation;

FIG. 8 illustrates the embodiment of FIG. 7 in a position/condition for use;

FIG. 9 illustrates the embodiment of FIG. 7 in a position/condition for use; and

FIG. 10A illustrates an alternate embodiment exemplary level;

FIG. 10B illustrates an alternate embodiment exemplary level;

FIG. 10C illustrates an alternate embodiment exemplary level;

FIG. 10D illustrates an alternate embodiment exemplary level; and

FIG. 10E illustrates an alternate embodiment exemplary level.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains. In the figures, like reference numerals designate like elements throughout.

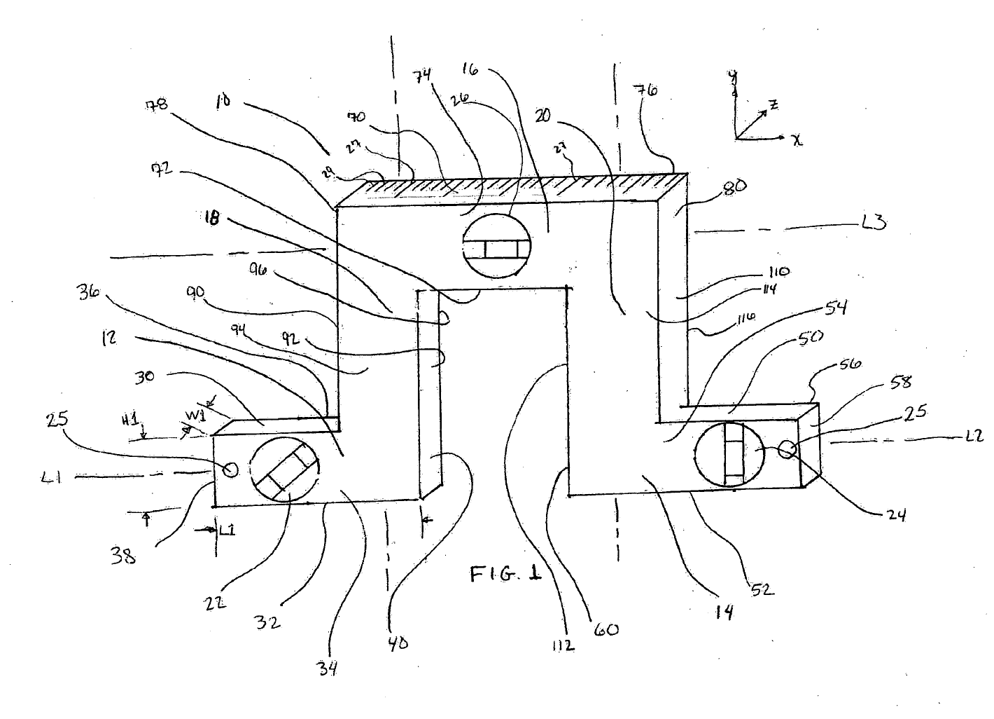

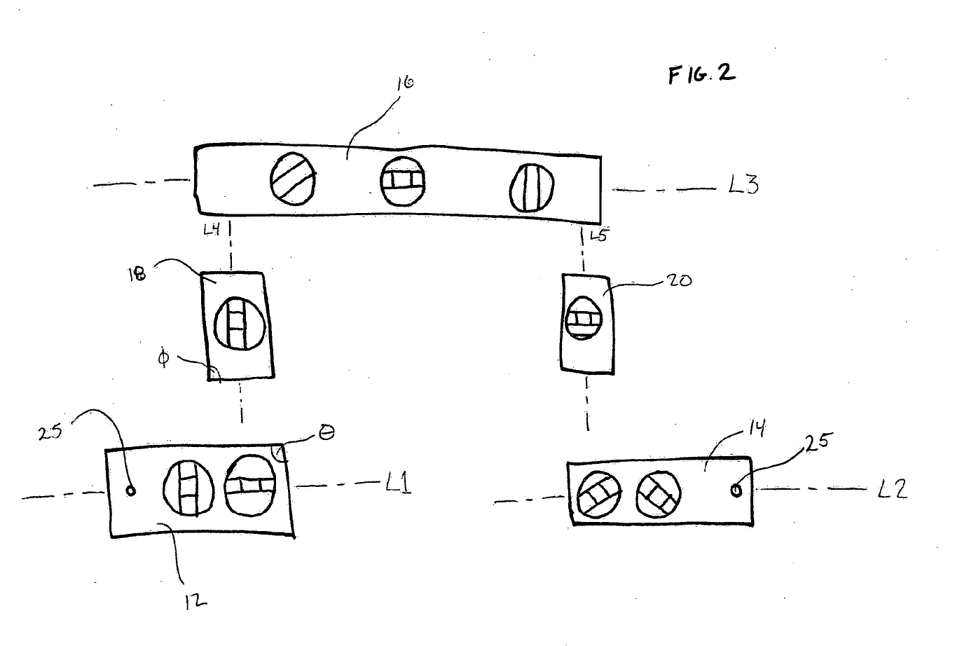

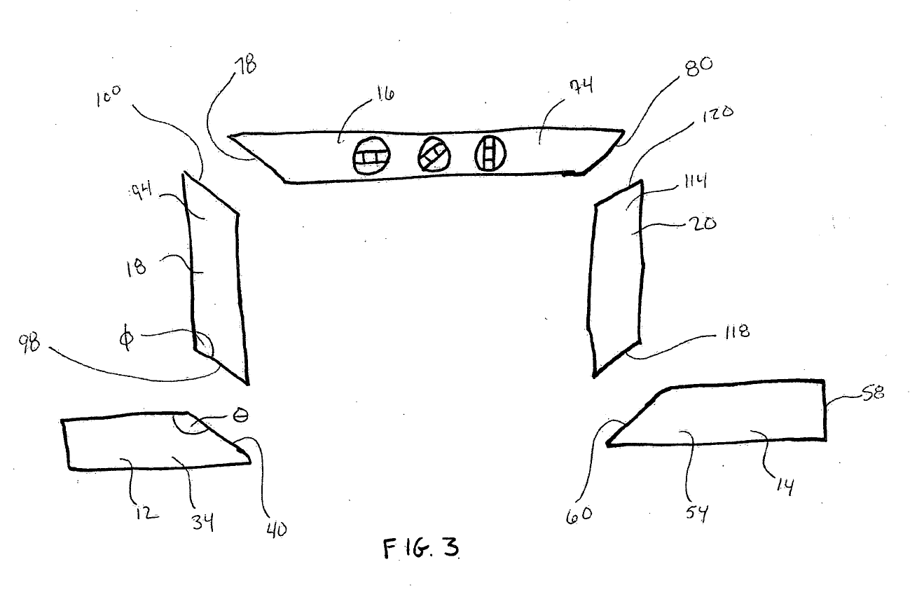

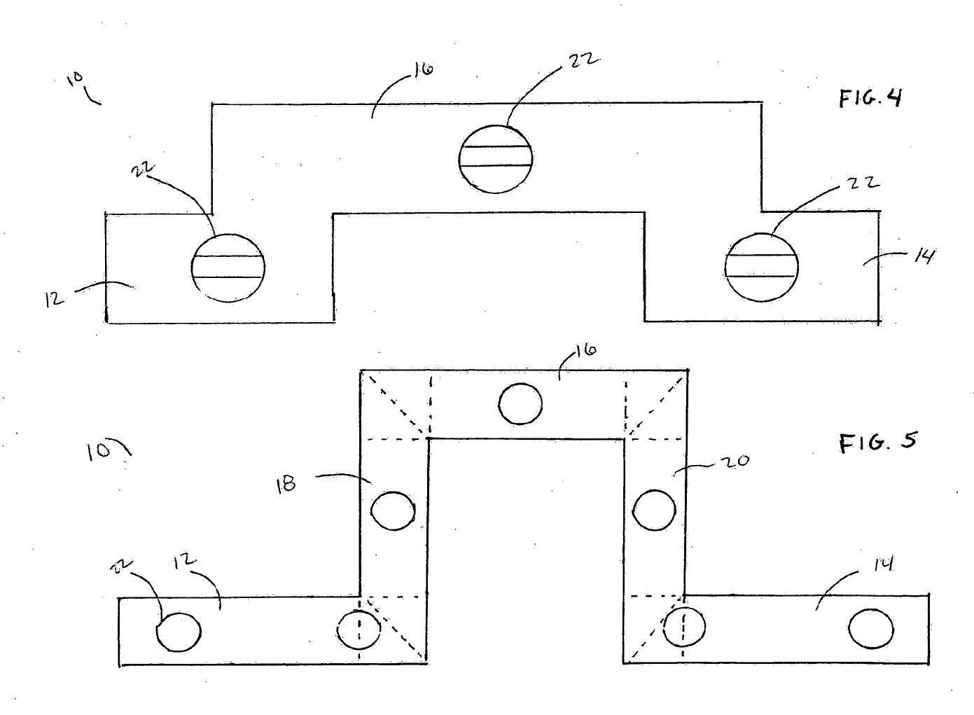

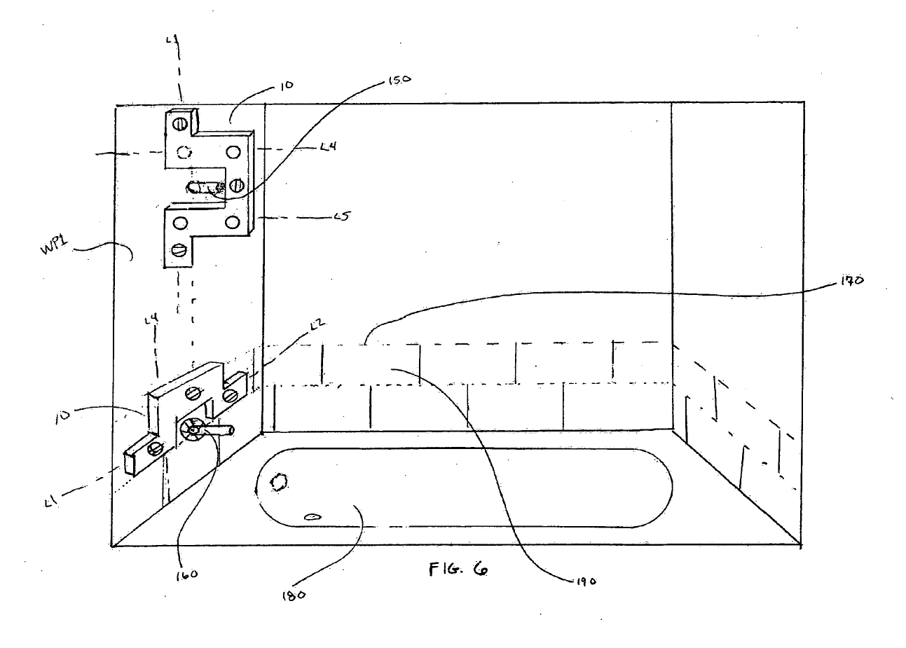

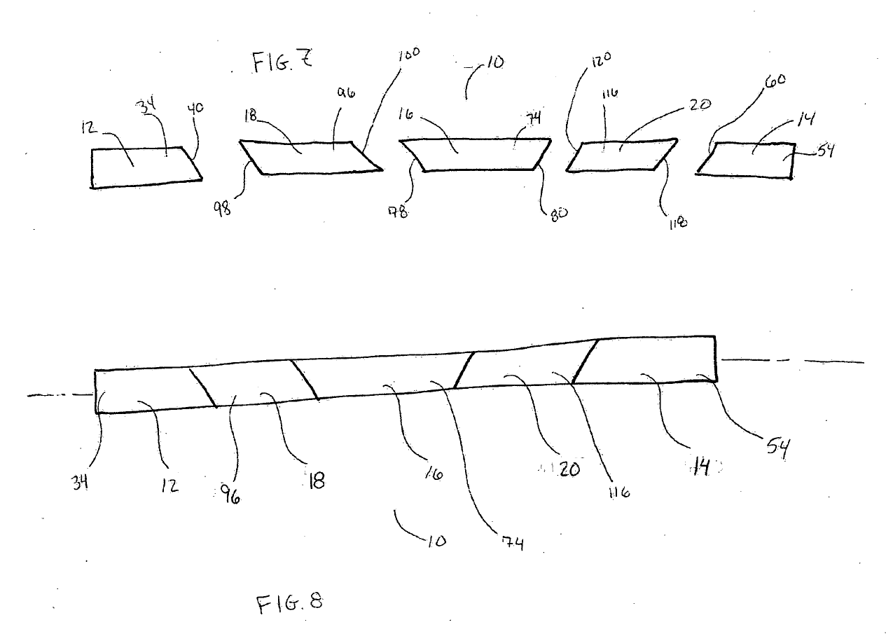

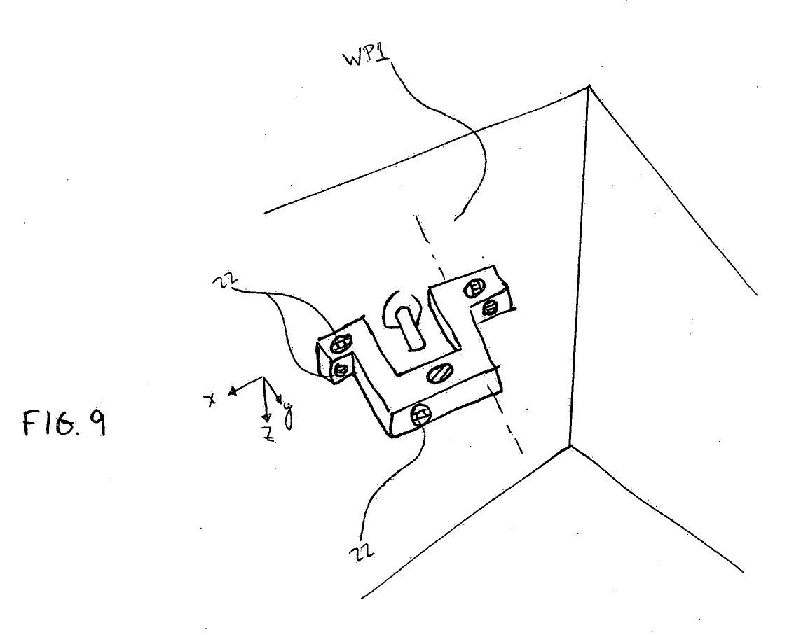

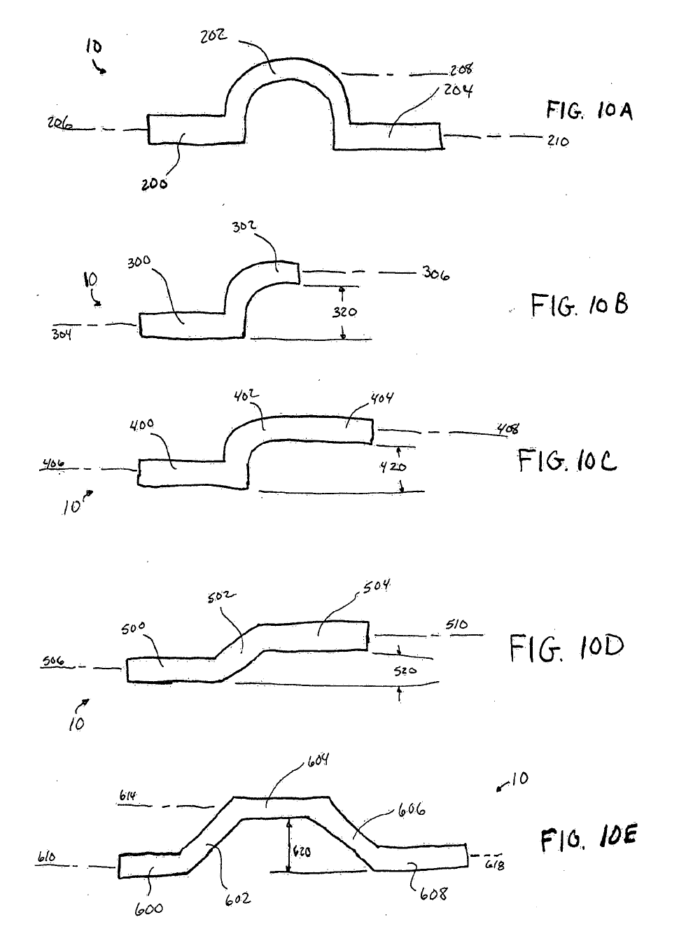

FIG. 1 depicts a perspective view of an exemplary embodiment of the present invention. FIG. 2 illustrates a front exploded view of another exemplary embodiment of the present invention. FIG. 3 illustrates a front exploded view of another exemplary embodiment of the present invention. FIG. 4 illustrates a front view of another exemplary embodiment of the present invention. FIG. 5 illustrates a front view of another exemplary embodiment of the present invention. FIG. 6 illustrates a perspective view of an exemplary level in use in a shower/tub setting. FIG. 7 illustrates an exploded view of the embodiment of FIG. 3 in which several members have been rotated so that the device is in a second orientation. FIG. 8 illustrates the embodiment of FIG. 7 in a position/condition for use. FIG. 9 illustrates the embodiment of FIG. 7 in a position/condition for use. FIG. 10A illustrates an alternate embodiment exemplary level. FIG. 10B illustrates an alternate embodiment exemplary level. FIG. 10C illustrates an alternate embodiment exemplary level. FIG. 10D illustrates an alternate embodiment exemplary level. FIG. 10E illustrates an alternate embodiment exemplary level.

FIG. 1 illustrates an exemplary embodiment offset level 10. In this embodiment, offset level 10 may be comprised of a variety components such as by a frame which may include a first portion 12, second portion 14, third portion 16, fourth portion 18 and fifth portion 20.

In this embodiment, first portion 12 has a first or top surface 30, second surface or bottom surface 32, front surface 34, back surface 36, first end surface 38, and distal end surface 40. First portion 12 has a length L1 (i.e., in the “x” direction as indicated in FIG. 1) which is a distance measured along second surface 32 from its intersection/edge with first end 38 to its intersection/edge with distal end 40, a height H1 (i.e., in the “y” direction as indicated in FIG. 1) measured along front surface 34 from its intersection/edge with first surface 30 to its intersection/edge with second surface 32, and a width W1 (i.e., in the “z” direction as indicated in FIG. 1) measured along first end surface 38 from its intersection/edge with front surface 34 to its intersection/edge with back surface 36.

Second portion 14 has a first surface 50, second surface 52, front surface 54, back surface 56, first end surface 58, and distal end surface 60. Similarly with first portion 12, second portion 14 has a height H2, width W2 and length L2.

Third portion 16 has a first surface 70, second surface 72, front surface 74, back surface 76, first end surface 78, and distal end surface 80. Third portion 16 has a height H3, width W3 and length L3.

Fourth portion 18 has a first surface 90, second surface 92, front surface 94, back surface 96, first end surface 98 (shown below), and distal end surface 100 (shown below). Fourth portion 18 has a height H4, width W4 and length L4.

Fifth portion 20 has a first surface 110, second surface 112, front surface 114, back surface 116, first end surface 118 (shown below), and distal end surface 120 (shown below). Fifth portion 20 has a height H5, width W5 and length L5.

The illustrated embodiment illustrates a first levelness indicator 22, second levelness indicator 24, and third levelness indicator 26 although other embodiments may have any number of levelness indicators. Each levelness indicator may comprise any suitable indicator of grade including, but not limited to, a bubble level indicator (as illustrated in FIG. 1), a laser level indicator, string, and chalk. In the illustrated embodiment of FIG. 1, levelness indicator 22 comprises a cylindrical shape 130 which extends from front surface 34 to back surface 36 and has therein a tube 132 which has therein a fluid and a certain amount of gas (note that it is not necessary for the levelness indicator to extend completely through the level, it may extend only partly through the level, or even be attached to an exterior to the level and may be either permanently attached or removable). Tube 132 has a certain curvature and a plurality of marks thereon

The device and/or one or more portions of it such as the frame may be of unitary construction or of multiple components and may be comprised of various materials including, but not limited to, plastic, metal, aluminum, steel, ceramic, and wood. In the embodiment illustrated in FIG. 1, the frame is comprised of multiple members or components such that the various components are welded to various other members. Various means may be utilized to secure the various components together such as, but not limited to, screws, gluing, bonding, bolting, welding, and snap fit.

Devices of the present invention may further comprise measure demarcations (such as English including, but not limited to, inches and multiples or fractions thereof or metric including, but not limited to, centimeters and multiples or fractions thereof). Such demarcations may be on any of the surfaces of the various portions or frame of the various embodiments. FIG. 1 illustrates one set of exemplary demarcations in which major demarcations 27 may indicate inches whereas minor demarcations 29 may indicate fifths of inches.

FIG. 2 illustrates an exemplary exploded view of various components of an exemplary embodiment of the present invention. In this embodiment, one can see first portion 12, second portion 14, third portion 16, fourth portion 18 and fifth portion 20. First portion 12 has a first surface 30, second surface 32, front surface 34, back surface 36, first end surface 38, distal end surface 40, and a longitudinal axis L1 which is parallel to first surface 30 and second surface 32 and is positioned midway between them. In this embodiment, first surface 32 meet with is distal end surface 40 at a ninety degree (90°) angle although such angle is variable in other embodiments. First portion 12 also has a longitudinal axis L1 which is parallel to first surface 30 and second surface 32 and is positioned midway between them.

Second portion 14 has a first surface 50, second surface 52, front surface 54, back surface 56, first end surface 58, distal end surface 60, and a longitudinal axis L2 which is parallel to first surface 50 and second surface 52 and is positioned midway between them.

Third portion 16 has a first surface 70, second surface 72, front surface 74, back surface 76, first end surface 78, and distal end surface 80, and a longitudinal axis L3 which is parallel to first surface 70 and second surface 72 and is positioned midway between them.

Fourth portion 18 has a first surface 90, second surface 92, front surface 94, back surface 96, first end surface 98, and distal end surface 100, and a longitudinal axis L4 which is parallel to first surface 90 and second surface 92 and is positioned midway between them.

Fifth portion 20 has a first surface 110, second surface 112, front surface 114, back surface 116, first end surface 118, and distal end surface 120, and a longitudinal axis L5 which is parallel to first surface 110 and second surface 112 and is positioned midway between them.

In this embodiment, first portion 12 and second portion 14 may be connected or adjoined to each other by any suitable means including, but not limited to, bonding, welding, gluing, and screwing. Such connection may be either temporary or permanent and may be such that the portions may rotate or pivot relative to each other. In other embodiments, the various portions may be unitarily constructed such that one or more of them may be pivotally or rotationally free to move or they may be fixed relative to one or more of the other portions.

A distance D1 is measured between longitudinal axis L1 and longitudinal axis L3. Similarly a distance D2 can be measured between longitudinal axis L1 and longitudinal axis L2. Similarly a distance D3 can be measured between longitudinal axis L4 and longitudinal axis L5.

FIG. 3 illustrates another embodiment in which the various portions have an alternate geometry from that in FIG. 2. In this embodiment, an angle Θ between first portion 12's first surface 30 and distal end surface 40 is approximately one hundred thirty-five degrees (135°) and an angle Φ between third portion 16's first surface 70 of and distal end surface 80 is approximately one hundred thirty-five degrees (135°).

In some embodiments, first portion 12 may be connected to fourth portion 18 such that a surface of first portion 12 is adjoined to a surface of fourth portion 18. In some embodiments, such as that illustrated in FIGS. 3-5, first portion 12 may be pivotably connected to fourth portion 18 such that the portions may rotate relative to each other. For example, in one embodiment pins may extend perpendicularly between the portions. In another embodiment, one or more ball bearing systems may allow one portion to pivot relative to an adjoining portion.

FIG. 4 illustrates another exemplary embodiment in which first portion 12's first surface is in substantially the same plane as third portion 16's second surface.

FIG. 5 illustrates another exemplary embodiment in which offset level 10 has a plurality of levelness indicators. In such an embodiment, the devices may be used in a multitude of orientations to provide a user with the ability to use the level to lay a line around objects which may protrude from a wall (for example) such as a shower head, faucet, electrical fixture, etc.

FIG. 6 illustrates an exemplary offset level in use in an exemplary installation shower/tub setting. In this illustration, a plurality of levels 10 are shown in a variety of configurations. In this illustration, note that level 10 may be oriented in various positions relative to the various walls. For example, in one illustration, axes L4, L5 of portions 18, 20 respectively are orthogonal with the plane of wall WP1. In another illustrated orientation, axes L4, l5 of portions 18, 20 may be parallel to the plane of wall WP1. Also shown are a variety of lines 170 which may be layed out around various objects such as shower head 150 and faucet 160. Also illustrated are various tiles 190.

FIG. 7 illustrates the alternate embodiment illustrated in FIG. 3 in which fourth portion 18 and fifth portion 20 have been rotated such that what was a back surface is now a front surface. Due to the angles Θ and Φ being functions or multiples of 45°, the portions may be rotated such that the device may be reconfigured to the orientation illustrated in FIG. 8.

FIG. 8 illustrates the present invention in an alternate configuration.

FIG. 9 illustrates a exemplary embodiment level in which a levelness indicator 22 is positioned such that the level may be used such that the longitudinal axes L4 of fourth portion 18 is perpendicular to wall plane WP1. For consistency, a representative coordinate plane system is illustrated by arrows x, y, z which is consistent with the coordinate plane system from FIG. 1. Thus, in this use, device 10 may be oriented such that wall plane WP1 is in the xz plane and longitudinal axis L4 (and in this embodiment longitudinal axis L5) are in the yz plane.

FIG. 10A illustrates an alternate embodiment in which level 10 includes a first linear portion 200, a curved portion 202, and a second linear portion 204. In this embodiment, there may be an offset between an axis of each of the respective portions such that a line may be layed out around an object. For example, there may be a distance between axis 206 of first portion 200 and axis 208 of portion 202. In this embodiment, axis 206 of portion 200 may be co-axial with axis 210 of portion 204.

FIG. 10B illustrates an alternate embodiment in which level 10 includes a first linear portion 300 and a curved portion 302. In this embodiment, there may be an offset between an axis of each of the respective portions such that a line may be layed out around an object. For example, there may be a distance between axis 304 of first portion 300 and axis 306 of portion 302. Distance 320 illustrates a minimum distance between a surface of portion 300 and a surface of portion 302. In some embodiments, distance 320 may be at least two (2) inches.

FIG. 10C illustrates an alternate embodiment in which level 10 includes a first linear portion 400, a curved portion 402, and a second linear portion 404. In this embodiment, there may be an offset between an axis of each of the respective portions such that a line may be layed out around an object. For example, there may be a distance between axis 406 of first portion 400 and axis 408 of portion 404. Distance 420 illustrates a minimum distance between a surface of portion 400 and a surface of portion 404. In some embodiments, distance 420 may be at least two (2) inches.

FIG. 10D illustrates an alternate embodiment in which level 10 includes a first linear portion 500, a second linear portion 502, and a third linear portion 504. In this embodiment, there may be an offset between an axis of each of the respective portions such that a line may be layed out around an object. For example, there may be a distance between axis 506 of first portion 500 and axis 510 of portion 504. Distance 520 illustrates a minimum distance between a surface of portion 500 and a surface of portion 504. In some embodiments, distance 520 may be at least two (2) inches.

FIG. 10E illustrates an alternate embodiment in which level 10 includes a first linear portion 600, a second linear portion 602, a third linear portion 604, a fourth linear portion 606, and a fifth linear portion 608. In this embodiment, there may be an offset between an axis of each of the respective portions such that a line may be layed out around an object. For example, there may be a distance between axis 610 of first portion 600 and axis 614 of portion 604. In this embodiment, axis 610 of portion 600 may be co-axial with axis 618 of portion 608. Distance 620 illustrates a minimum distance between a surface of portion 600 and a surface of portion 604. In some embodiments, distance 620 may be at least two (2) inches.

### Illustrative Use of an Exemplary Embodiment

An illustrative manner of using such an exemplary level is now described below. Note that the above description and the use described herein should be considered together to fully illustrate the concept of the present level.

The embodiment described above with regard to FIG. 1 is an offset level 10 comprised of a frame which may be comprised of various portions 12, 14, 16, 18, 20 with one or more levelness indicators 22 and which may also include measuring demarcations. The levelness indicators 22 may be mounted to the frame of the level by various mountings as discussed above or they may be unitary with level 10.

The exemplary level may be used by a person in several manners to determine level points around objects which would interfere with use of a conventional straight level in laying a line. The basic principles of using the offset level are similar to conventional levels in this field. A first point is determined that one desires to be the reference point. The offset level 10 is then held by hand or attached in respect to the reference point by hanging the level from one of the mounting holes 25. The other end of the offset level is then routed around the object which was in the way, and then the user can adjust the level up and down (for a horizontal “level” use) or back and forth (for a vertical “plumb” use) until the levelness indicator 22 aligns itself in the glass of the device and indicates level or plumb condition, respectively. When this condition of level or plumb is achieved, the person can then demark or indicate a second point or line at the edge of the level that is, in fact, in a level (or plumb) condition with respect to the first reference point.

One possible advantage of having a portion of the frame of the level offset is readily understood by one skilled in the art. The ability to mark a level line around an object or objects such as pieces of pipes, knobs, wallplates, fixtures, lights, etc. are but a few examples. Further examples of uses for the offset level are in marking interior or exterior corner structures to enable a person to efficiently determine a level condition. This condition is helpful for example to hang pictures; to properly place moldings such as chair rails; or to permit one to maintain a level line for a painting or a wall papering design scheme. These uses for indicating a level condition on odd shaped objects and corner structures are merely exemplary and not limiting to the myriad of uses for a tool that is flexible such as the present device.

The various components and members of the present invention may be comprised wholly or in part of any suitable materials including, but not limited to, steel, aluminum, ceramic, wood, alloys, plastic, rubber, carbon fiber, fiberglass, and stainless steel. The various members and components of levels described herein may have any suitable cross sectional shape including, but not limited to, substantially rectangular, square, round, elliptical,

While the specification has been described in detail with respect to specific embodiments thereof, it will be appreciated that those skilled in the art, upon attaining an understanding of the foregoing, may readily conceive of alterations to, variations of, and equivalents to these embodiments. Also note that the housing and other components may be of any suitable shape depending on the desired application for the device. Accordingly, the scope of the present invention should be assessed as that of the appended claims and any equivalents thereto.

What is claimed is:

1. An offset level, said level comprising:
a frame having:
a first portion having a first surface, a second surface, a front surface, a back surface a first end surface and a distal end surface,
a second portion having a first surface, a second surface, a front surface, a back surface a first end surface and a distal end surface, and
a third portion having a first surface, a second surface, a front surface, a back surface a first end surface and a distal end surface,
wherein said top surface of said first portion and said top surface of said second portion are co-planar and said top surface of said third portion is not co-planar with either of said top surfaces of said first or second portions.

2. The level of claim 1, further comprising at least one levelness indicator which is capable of indicating whether said level is in at least one of a horizontal condition, a vertical condition or a 45 degree angle between said vertical condition and said horizontal condition.

3. The level of claim 1, further comprising:
a longitudinal axis located midway between said first and second surfaces of said first portion,
a longitudinal axis located midway between said first and second surfaces of said second portion,
a longitudinal axis located midway between said first and second surfaces of said third portion, and
wherein said longitudinal axis of said first portion is not co-axial with said longitudinal axis of said third portion.

4. The level of claim 1, wherein a distance measured between said first surface of said first portion and said first surface of said third portion is at least one inch.

5. The level of claim 1, wherein a distance measured between said first surface of said first portion and said first surface of said third portion is at least four inches.

6. The level of claim 1, further comprising a fourth portion and a fifth portion wherein said fourth portion connects said first portion to said third portion,
and said fifth portion connects said second portion to said third portion.

7. The level device according to claim 2 wherein the levelness indicator is a spirit level.

8. The level of claim 1, further comprising a linear distance indicator wherein said linear distance indicator is in units selected from the group consisting of English and metric.

9. An offset level, said level comprising:
a frame having:
a first portion having a first surface, a second surface, a front surface, a back surface a first end surface and a distal end surface,
a second portion having a first surface, a second surface, a front surface, a back surface a first end surface and a distal end surface, and
a third portion having a first surface, a second surface, a front surface, a back surface a first end surface and a distal end surface,
a longitudinal axis located midway between said first and second surfaces of said first portion,
a longitudinal axis located midway between said first and second surfaces of said second portion
a longitudinal axis located midway between said first and second surfaces of said third portion
wherein said longitudinal axis of said first portion is not co-axial with said longitudinal axis of said third portion.

10. The level device according to claim 9 wherein the main body has an aperture at either end whereby said aperture permits the person using the device to attach the level to the surface that the user is measuring for levelness.

11. The device of claim 9 wherein each of said portions is in a fixed relation to each of the other of said portions.

12. An offset level for use by one person on a surface with one or more surface obstructions which prevent a user from laying a line on both sides of said obstruction, the offset level comprising:
(a) a frame having:
a first portion having a first surface, a second surface, a front surface, a back surface a first end surface and a distal end surface,
a second portion having a first surface, a second surface, a front surface, a back surface a first end surface and a distal end surface, and
a third portion having a first surface, a second surface, a front surface, a back surface a first end surface and a distal end surface,
wherein said top surface of said first portion and said top surface of said second portion are co-planar and said top surface of said third portion is not co-planar with either of said top surfaces of said first or second portions; and
(b) at least one levelness indicator which is capable of indicating whether said level is in at least one of a horizontal condition, a vertical condition or a 45 degree angle between said vertical condition and said horizontal condition.
